(19) United States
(12) Patent Application Publication
(10) Pub. No.: US 2009/0029298 A1
(43) Pub. Date: Jan. 29, 2009

(54) METHOD OF MANUFACTURING PATTERNED MAGNETIC RECORDING MEDIUM

(75) Inventors: Du-hyun LEE, Suwon-si (KR); Sung-hoon CHOA, Seoul (KR); Jin-seung SOHN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/939,766

(22) Filed: Nov. 14, 2007

(30) Foreign Application Priority Data
Jul. 24, 2007 (KR) 10-2007-0074122

(51) Int. Cl. G03G 5/16

(52) U.S. Cl. 430/327

(57) ABSTRACT

Provided is a method of manufacturing a patterned magnetic recording medium. The method includes (a) forming a patterned recording layer on an underlayer of a first substrate; (b) coating a polymer layer on a surface of a second substrate; (c) transferring the polymer layer on the patterned recording layer; and (d) exposing the surface of the patterned recording layer.

### CROSS-REFERENCE TO RELATED PATENT APPLICATION

This application claims the benefit of Korean Patent Application No. 10-2007-0074122, filed on Jul. 24, 2007, in the Korean Intellectual Property Office, the disclosure of which is incorporated herein in its entirety by reference.

### BACKGROUND OF THE INVENTION

1. Field of the Invention

The present invention relates to a method of manufacturing a patterned magnetic recording medium, and more particularly, to a method of manufacturing a patterned magnetic recording medium having a recording layer with a flat surface.

2. Description of the Related Art

Hard disc drives that use magnetic recording media have large recording capacity and high access speed, and thus, they have received much attention for use as information memory apparatuses not only for computers but also for various digital apparatuses. Recently, due to the wide use of information systems, the amount of information exchanged over various networks has increased enormously. Thus, high density hard disc drives need to be developed.

As the recording density increases, the bit size, which is the minimum recording unit of data, has to be reduced, and in addition, the intensity of magnetic signals generated from a magnetic recording medium needs also to be reduced. Accordingly, it is important to reduce noise from a medium in order to obtain a high signal to noise ratio (SNR). Noise is generally caused at a transition region between consecutive magnetic domains. Thus, in the case of a continuous magnetic recording medium having a continuous recording layer in which magnetic domains are consecutively connected, if the bit size is reduced below a certain value, noise is increased in adjacent regions, and accordingly, the recording stability is rapidly reduced. Thus, there is a limit in increasing the recording density.

To further increase the recording density, patterned magnetic recording media such as discrete track media or bit patterned media have been proposed. In the case of a patterned magnetic recording medium, a recording layer in which data are recorded is patterned into a predetermined pattern in order to structurally separate the magnetic domains from each other. Thus, the surface of the patterned magnetic recording medium should be made flat like that of a continuous magnetic recording medium by filling a nonmagnetic material in groove regions between the patterns of the recording layer. If the surface of the patterned magnetic recording medium is not flat, the flying height of a read/write head with respect to the magnetic recording medium is unstable, and thus, the recording/reproducing characteristics of the magnetic recording medium are degraded.

FIGS. 1A through 1C are cross-sectional views for illustrating a method of manufacturing a patterned magnetic recording medium having a flat surface. Referring to FIG. 1A, an underlayer 12 and a patterned recording layer 14 are formed on a substrate 10. Referring to FIG. 1B, a nonmagnetic layer 16 formed of SiO₂ is deposited on the patterned recording layer 14. Referring to FIG. 1C, the nonmagnetic layer 16 is etched until the surface of the patterned recording layer 14 is exposed.

The method described above includes a deposition process and an etching process, which are quite expensive. Also, the nonmagnetic layer 16 must be deposited to be thick for planarization process, and a strict control of the etching process is needed to ensure accurate exposure of the surface of the patterned recording layer 14.

### SUMMARY OF THE INVENTION

To address the above and/or other problems, the present invention provides a method of manufacturing a patterned magnetic recording medium having a planarized surface.

According to an aspect of the present invention, there is provided a method of manufacturing a patterned magnetic recording medium comprising: (a) forming a patterned recording layer on an underlayer of a first substrate; (b) coating a polymer layer on a surface of a second substrate; (c) transferring the polymer layer on the patterned recording layer; and (d) exposing the surface of the patterned recording layer.

The transferring of the polymer layer on the patterned recording layer may comprise: imprinting the polymer layer onto the patterned recording layer after the second substrate on which the polymer layer is formed is placed on the patterned recording layer of the first substrate so that the polymer layer faces the patterned recording layer; and separating the second substrate from the polymer layer.

According to another aspect of the present invention, there is provided a method of manufacturing a patterned magnetic recording medium comprising: (a) forming a patterned recording layer on an underlayer of a first substrate; (b) coating a polymer layer on the patterned recording layer; (c) imprinting a second substrate after placing the second substrate on the polymer layer; (d) separating the second substrate from the polymer layer; and (e) exposing a surface of the patterned recording layer.

The imprinting the second substrate may be performed by radiating ultraviolet rays through the second substrate and simultaneously pressing the second substrate.

The method may further comprise performing a release treating of the surface of the second substrate so that the second substrate is readily separated from the polymer layer.

The method may further comprise performing a surface contact increasing treatment of the patterned recording layer in order to increase the contact between the polymer layer and the second substrate.

### BRIEF DESCRIPTION OF THE DRAWINGS

The above and other features and advantages of the present invention will become more apparent by describing in detail exemplary embodiments thereof with reference to the attached drawings in which:

FIGS. 1A through 1C are cross-sectional views for illustrating a conventional method of manufacturing a patterned magnetic recording medium having a flat surface;

FIGS. 2A through 2E are cross-sectional views for illustrating a method of manufacturing a patterned magnetic recording medium according to an embodiment of the present invention; and

FIGS. 3A through 3E are cross-sectional views for illustrating a method of manufacturing a patterned magnetic recording medium according to another embodiment of the present invention.

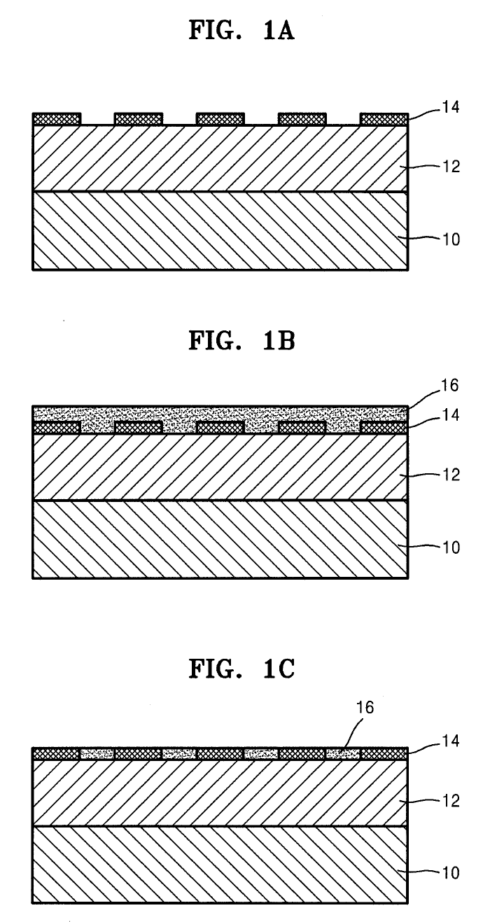

### DETAILED DESCRIPTION OF THE INVENTION

The present invention will now be described more fully with reference to the accompanying drawings in which exemplary embodiments of the invention are shown. In the drawings, the thicknesses of layers and regions are exaggerated for clarity, and like reference numerals refer to like elements.

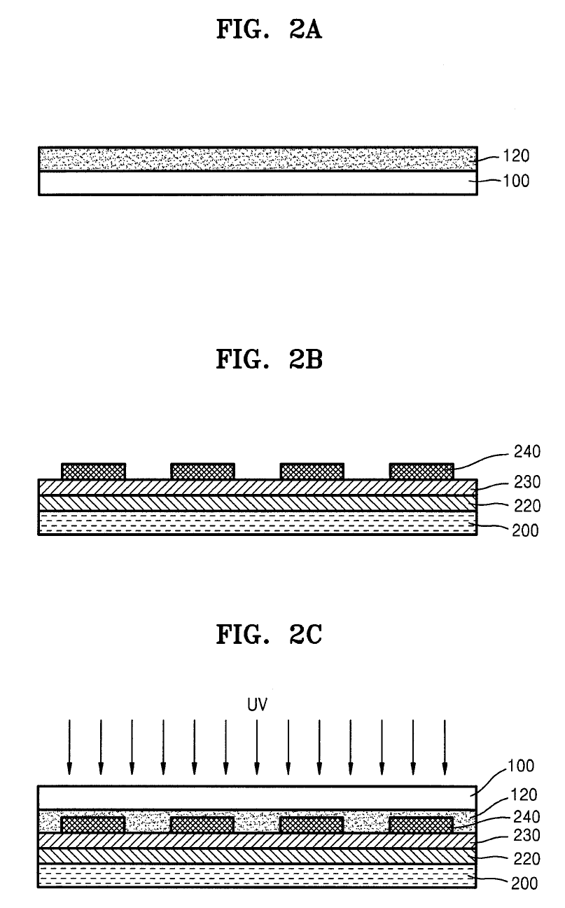

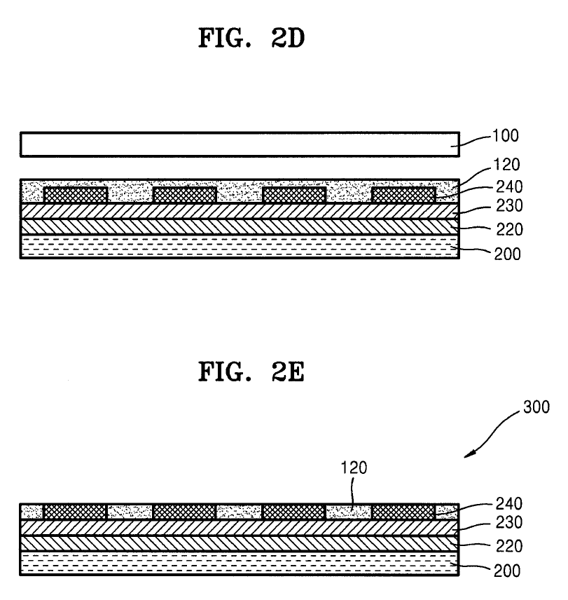

FIGS. 2A through 2E are cross-sectional views for illustrating a method of manufacturing a patterned magnetic recording medium according to an embodiment of the present invention. Referring to FIG. 2A, an underlayer and a patterned recording layer 240 are sequentially formed on a first substrate 200. The underlayer includes a soft magnetic layer 220 and an intermediate layer 230. The soft magnetic layer 220 may be formed of a soft magnetic material that includes one of Co, Fe, and Ni. The intermediate layer 230 is formed to increase the magnetic characteristics of the patterned recording layer 240, and can be formed of an alloy that includes one of, for example, Ru, MgO, and Ni. The patterned recording layer 240 is a layer in which information is recorded with a form of magnetization, and, for example, can be formed in a magnetic thin film structure or a magnetic multilayer thin film structure that includes one Co, Fe, Pt, and Pd, which have high perpendicular magnetic anisotropy. The patterned recording layer 240 can be formed using a conventional method of patterning a thin film and, for example, may be formed as a discrete track medium or a bit patterned medium using photolithography or nano imprinting. The method of forming the patterned recording layer 240 is well known in the art, and thus a detailed description thereof will be omitted.

Referring to FIG. 2B, a polymer layer 120, which is a nonmagnetic layer, is formed on a second substrate 100. The second substrate 100 can be a transparent substrate formed of glass, quartz, or polyethylene terephthalate (PET). The polymer layer 120 is formed by coating an ultraviolet curable polymer or a thermal polymer on the second substrate 100. For example, the polymer layer 120 can be formed of an acrylate group organic polymer or an organic-inorganic hybrid polymer that contains a photo initiator or an ultraviolet curable negative photoresist. Also, the polymer layer 120 can be formed of a thermal imprint resin such as polymethylmethacrylate (PMMA), or inorganic spin-on-glass polymer such as hydrogen silsesquioxane (HSQ). The polymer layer 120 can be formed using dispensing, spin coating, spray coating, dip coating, ink jet coating, or vacuum deposition.

A process for release treating of a surface of the second substrate 100 can further be included prior to forming the polymer layer 120 on the second substrate 100. Since the polymer layer 120 is separated from the patterned recording layer 240 after the polymer layer 120 is transferred onto the patterned recording layer 240, release treating of the surface of the second substrate 100 is performed so that the polymer layer 120 can be readily separated from the patterned recording layer 240. The release treating of the surface of the second substrate 100 can be achieved by hydrophobic coating the surface of the second substrate 100. For example, after the surface of the second substrate 100 is activated by O₂ ashing, a self assembled monolayer is deposited on the surface of the second substrate 100 by vaporizing FOTS( (tridecafluoro-1,1,2,2-tetrahydrooctyl)-trichlorosilane, [CF3-(CF2)5-CH2-CH2-SiCl3]) in a vacuum chamber. By the hydrophobic coating, a low surface energy having a water contact angle of approximately 110° can be obtained.

Referring to FIG. 2C, after the second substrate 100 on which the polymer layer 120 is formed is placed on the patterned recording layer 240 so that the polymer layer 120 can face the patterned recording layer 240, the resultant product is imprinted. The imprinting process is performed by radiating ultraviolet rays through the second substrate 100 and pressing the resultant product. Alternatively, the imprinting process can be performed by applying heat and pressure according to the material for forming the polymer layer 120. In this case, the second substrate 100 can be an opaque substrate. Prior to performing the imprinting process, an adhesive strength improving treatment can be performed on the surface of the patterned recording layer 240. The adhesive strength improving treatment is a treatment to increase the contact between the polymer layer 120 and the patterned recording layer 240 by increasing the surface energy of the patterned recording layer 240 so that the polymer layer 120 can closely contact the patterned recording layer 240 and, in a subsequent process, the first substrate 200 can be readily separated from the polymer layer 120. For example, the adhesive strength between the patterned recording layer 240 and an organic group polymer can be increased by increasing the density of hydroxyl group on the surface of the patterned recording layer 240 by activating the surface of the patterned recording layer 240 using O₂ ashing and, by coating a silane coupling agent on the surface of the patterned recording layer 240.

Referring to FIG. 2D, the second substrate 100 is separated from the polymer layer 120. The second substrate 100 can be readily separated from the polymer layer 120 due to the release treating for the surface of the second substrate 100 and the adhesive strength improving treatment for the patterned recording layer 240. After the second substrate 100 is separated from the first substrate 200, hardening of the polymer layer 120 can further be performed when necessary by ultraviolet ray exposing or hard baking. As depicted in FIG. 2E, the surface of the patterned recording layer 240 is exposed by removing the polymer layer 120 covering the surface of the patterned recording layer 240, for example, by using O₂ plasma ashing. Through the above processes, a patterned magnetic recording medium 300 having a flat surface is manufactured.

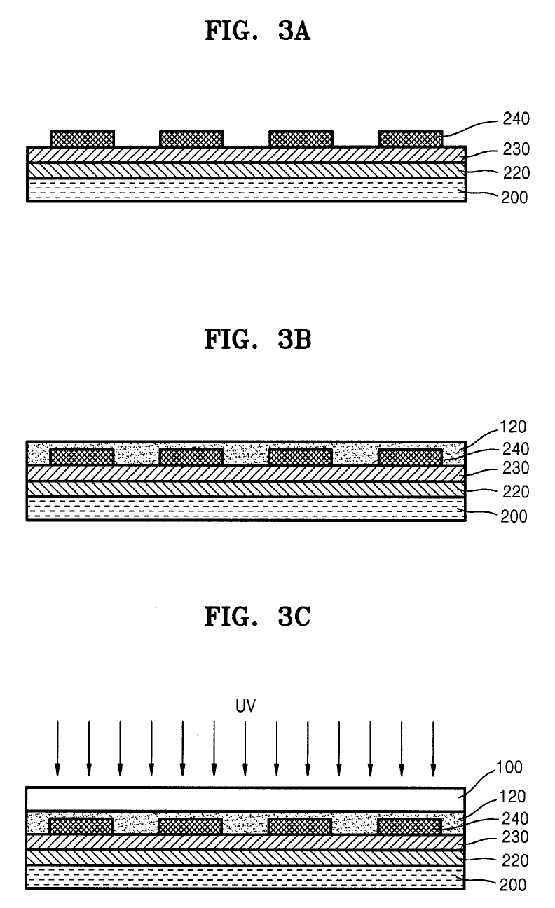

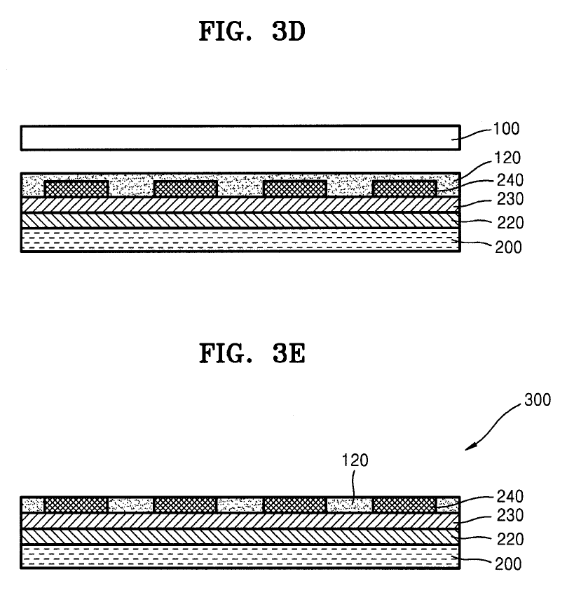

FIGS. 3A through 3E are cross-sectional views for illustrating a method of manufacturing a patterned magnetic recording medium 300 according to another embodiment of the present invention. The present embodiment is different from the previous embodiment described with reference to FIGS. 2A through 2E in that a polymer layer 120 is directly coated on a patterned recording layer 240. Thus, only this difference will be described. Elements that are not described are the same as the elements depicted in FIGS. 2A through 2E. Referring to FIG. 3A, the patterned recording layer 240 is formed on an underlayer that is formed of a soft magnetic layer 220 and an intermediate layer 230. After the patterned recording layer 240 is formed, as described above, a process of adhesive strength improving treatment can be performed on a surface of the patterned recording layer 240. Referring to FIG. 3B, a polymer layer 120, which is a non-magnetic layer, is formed on the patterned recording layer 240. Referring to FIG. 3C, after the second substrate 100 is placed on the polymer layer 120, an imprinting process is performed. Prior to placing the second substrate 100 on the polymer layer 120, as described above, a release treating process can be performed on the surface of the second substrate 100. The imprinting process can be performed by radiating ultraviolet rays through the second substrate 100 and simultaneously pressing the second substrate 100, or can be performed by applying heat and pressure through the second substrate 100 according to the material of the polymer layer 120. In each imprinting case, the second substrate 100 can be a transparent substrate or an opaque substrate, respectively. Referring to FIG. 3D, the second substrate 100 is separated from the polymer layer 120. At this point, as described above, the separation of the second substrate 100 from the polymer layer 120 can be readily performed due to the release treating for the surface of the second substrate 100 and the adhesive strength improving treatment for the patterned recording layer 240. Next, the polymer layer 120 is removed so that the surface of the patterned recording layer 240 is exposed. The removal of the polymer layer 120 can be performed using O₂ plasma ashing. Through the above processes, the patterned magnetic recording medium 300 is manufactured.

An aspect of the method of manufacturing the patterned magnetic recording medium 300 according to the present invention is that, in order to manufacture the patterned magnetic recording medium 300, groove regions in the patterned recording layer 240 are filled with a polymer using a nano imprinting process. Regarding the other processes, one of ordinary skill in the art would readily understand that the operation of forming the patterned recording layer 240, the materials for the patterned recording layer 240, the soft magnetic layer 220, and the intermediate layer 230 can be changed in various ways in order to increase the recording characteristics of the patterned magnetic recording medium 300. Also, each step of the method of manufacturing the patterned magnetic recording medium 300 can vary according to, for example, the material for forming the polymer layer 120.

According to the method of manufacturing a patterned magnetic recording medium, a planarization process of a magnetic recording medium is performed without using deposition and etching processes. Thus, the manufacturing process is simple compared to the conventional method and the manufacturing costs can be reduced.

While the method of manufacturing a patterned magnetic recording medium according to the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a patterned magnetic recording medium, comprising:
(a) forming a patterned recording layer on an underlayer of a first substrate;
(b) coating a polymer layer on a surface of a second substrate;
(c) transferring the polymer layer on the patterned recording layer; and
(d) exposing the surface of the patterned recording layer.

2. The method of claim 1, wherein the transferring of the polymer layer on the patterned recording layer comprises:
imprinting the polymer layer onto the patterned recording layer after the second substrate on which the polymer layer is formed is placed on the patterned recording layer of the first substrate so that the polymer layer faces the patterned recording layer; and
separating the second substrate from the polymer layer.

3. The method of claim 2, wherein the imprinting the polymer layer onto the patterned recording layer is performed by radiating ultraviolet rays through the second substrate and simultaneously pressing the second substrate.

4. The method of claim 3, wherein the second substrate is a transparent substrate.

5. The method of claim 2, wherein the imprinting the polymer layer onto the patterned recording layer is performed by applying heat and simultaneously pressing the second substrate.

6. The method of claim 5, wherein the second substrate is an opaque substrate.

7. The method of claim 1, further comprising performing a release treating on the surface of the second substrate prior to coating the polymer layer on the second substrate.

8. The method of claim 7, wherein the performing the release treating of the surface of the second substrate comprises:
activating the surface of the second substrate by O₂ ashing; and
depositing FOTS((tridecafluoro-1,1,2,2-tetrahydrooctyl)-trichlorosilane) on the activated surface of the second substrate.

9. The method of claim 1, further comprising an adhesive strength improving treatment for the patterned recording layer prior to performing the transferring operation.

10. The method of claim 9, wherein the performing of the adhesive strength improving treatment of the patterned recording layer comprises:
activating the surface of the patterned recording layer by O₂ ashing; and
coating a silane coupling agent on the patterned recording layer.

11. The method of claim 1, further comprising hardening the polymer layer after performing the transferring operation.

12. The method of claim 11, wherein the hardening of the polymer layer is performed by radiating ultraviolet ray or a hard baking process.

13. The method of claim 1, wherein the exposing of the surface of the patterned recording layer is performed by O₂ plasma ashing.

14. A method of manufacturing a patterned magnetic recording medium, comprising:
(a) forming a patterned recording layer on an underlayer of a first substrate;
(b) coating a polymer layer on the patterned recording layer;
(c) imprinting a second substrate after placing the second substrate on the polymer layer;
(d) separating the second substrate from the polymer layer; and
(e) exposing a surface of the patterned recording layer.

15. The method of claim 14, wherein the imprinting the second substrate is performed by radiating ultraviolet rays through the second substrate and simultaneously pressing the second substrate.

16. The method of claim 15, wherein the second substrate is transparent substrate.

17. The method of claim 14, wherein the imprinting the second substrate is performed by applying heat to the second substrate and simultaneously pressing the second substrate.

18. The method of claim 17, wherein the second substrate is an opaque substrate.

19. The method of claim 14, further comprising performing a release treating on the surface of the second substrate prior to performing the imprinting operation.

20. The method of claim 19, wherein the performing of the release treating of the surface of the second substrate comprises:
activating the surface of the second substrate by O₂ ashing; and
depositing FOTS((tridecafluoro-1,1,2,2-tetrahydrooctyl)-trichlorosilane) on the activated surface of the second substrate.

21. The method of claim 14, further comprising performing an adhesive strength improving treatment on the patterned recording layer prior to coating the polymer layer on the patterned recording layer.

22. The method of claim 9, wherein the adhesive strength improving treatment of the patterned recording layer comprises:
activating the surface of the patterned recording layer by O₂ ashing; and
coating a silane coupling agent on the patterned recording layer.

23. The method of claim 14, further comprising hardening the polymer layer after separating the second substrate from the polymer layer.

24. The method of claim 14, wherein the exposing of the surface of the patterned recording layer is performed by O₂ plasma ashing.

25. The method of claim 1, wherein the polymer layer is formed of one selected from the group consisting of an organic polymer, organic-inorganic hybrid polymer), PMMA (polymethylmethacrylate), HSQ (hydrogen silsesquioxane), and inorganic spin-on-glass polymer.
